(19) United States
(12) Patent Application Publication
(10) Pub. No.: US 2010/0040099 A1
(43) Pub. Date: Feb. 18, 2010

(54) Bias Signal Generation for a Laser Transmitted in a Passive Optical Network

(75) Inventors: Henry Blauvelt, San Marino, CA (US); Bryon L. Kasper, San Marino, NC (US)

Correspondence Address: EMCORE CORPORATION, 1600 EUBANK BLVD, S.E., ALBUQUERQUE, NM, 87123, US

(73) Assignee: Emcore Corporation, Albuquerque, NM (US)

(21) Appl. No.: 12/190,754

(22) Filed: Aug. 13, 2008

(51) Int. Cl. H01S 3/13

(52) U.S. Cl. 372/31

(57) ABSTRACT

The teachings presented herein disclose a method and apparatus for controlling the optical power of a laser in a passive optical network transmitter that outputs a modulated optical signal responsive to a modulated input signal. In one or more embodiments, such a control method comprises detecting the peak amplitude of the modulated input signal, and setting the DC bias level of the laser as a function of the detected peak amplitude. These teachings may be implemented, for example, by a laser control circuit in the transceiver module of an optical network unit (“ONU”). Such an ONU may be advantageously used in a hybrid coaxial cable-optical fiber network, such as used in DPONs which interface cable system subscriber equipment to cable system head-end equipment.

### RELATED APPLICATIONS

This application is related to co-pending U.S. application Ser. No. 12/045,541, filed on 10 Mar. 2008.

### TECHNICAL FIELD

This disclosure relates to passive optical networks laser control in a passive optical network (“PON”), and particularly relates to bias signal generation for a laser transmitter used to output optical signals for transmission in a PON.

### DESCRIPTION OF THE RELATED ART

Fiber optic technology has been recognized for its high bandwidth capacity over longer distances, enhanced overall network reliability and service quality. Fiber to the premises (“FTTP”), as opposed to fiber to the node (“FTTN”) or fiber to the curb (“FTTC”) delivery, enables service providers to deliver substantial bandwidth and a wide range of applications directly to business and residential subscribers. For example, FTTP can accommodate the so-called “triple-play” bundle of services, e.g., high-speed Internet access and networking, multiple telephone lines and high-definition and interactive video applications.

However, utilizing FTTP involves equipping each subscriber premises with the ability to receive optical signals and convert them into electrical signals compatible with pre-existing wiring in the premises (e.g., twisted pair and coaxial). For bidirectional communication with the network, the premises should be equipped with the ability to convert outbound electrical signals into optical signals. In some cases, these abilities are implemented using a passive optical network (“PON”).

Generally speaking, a PON is a point-to-multipoint fiber to the premises network architecture in which un-powered optical splitters are used to enable a single optical fiber to serve multiple subscriber premises, e.g., 16 subscribers, 32 subscribers, etc. A PON generally includes an optical line termination (“OLT”) at the service provider's central office, and a gateway device at each end user location. For example, the premises equipment at each subscriber location may couple to the PON via an optical network unit (“ONU”).

To provide gateway functionality, each ONU includes a “transceiver module.” A transceiver module generally includes a laser and associated driver circuitry to convert electrical signals outgoing from the subscriber equipment into optical signals for upstream transmission within the PON. Correspondingly, the transceiver module includes an optical receiver to convert downstream optical signals incoming from the PON into electrical signals for the subscriber equipment. ONU implementation, and particularly, transceiver module implementation, varies with the type of PON.

For example, at least some implementation details differ between baseband digital PONs and so-called “DPONs.” In baseband digital PONs, the network sends timing information directly to the circuitry that controls transceiver laser power, allowing the laser to be turned on immediately before data is to be transmitted. However, in a “DPON” transmission, timing information generally is not available from the network for laser control.

In more detail, DPONs take their name from the Data Over Cable Service Interface Specification (“DOCSIS”). This specification defines industry standards for the operation of cable modems and the cable modem termination systems (CMTS) at the network head end. The DOCSIS standards define such things as the format for the modulated digital RF carriers used for communicating between a CMTS and its associated cable modems, the frequencies and RF power levels for transmissions, and the process for requesting and being granted permission to transmit over the cable network.

However, the DOCSIS standards assume that the cable network connections between the CMTS and the cable modems will be by coaxial cable and not optical fiber. Therefore, DOCSIS does not make provisions for providing cable network timing or control information to a DPON being used to interconnect a CMTS with subscriber modems. Indeed, the DPON must operate transparently with respect to the cable system. As such, the OTU at the cable head end and the respective ONUs at the subscriber premises convert the electrical/RF signals going between the CMTS and respective subscriber equipment into optical signals for transport via the DPON, without interfering with normal cable system operation.

Because timing and control signaling from the cable system are not provided to the DPON, certain challenges arise with respect to laser control and operation. For example, the gateway devices coupling subscriber equipment to the PON must autonomously determine when to turn on their lasers for upstream optical transmission. In one approach, a given gateway device turns on its laser power responsive to blindly detecting the presence of a modulated input signal (e.g., an RF signal) originating from its corresponding subscriber equipment.

Another concern not addressed by DOCSIS is the laser DC bias level to be used in the transceiver module at a given subscriber location, for converting upstream electrical/RF signals into optical signals for transmission over the DPON. Ideally, one would set the DC laser bias to a level that maximizes carrier-to-noise and carrier-to-distortion levels in the DPON. Of course, the DC bias level that achieves those goals varies as a function of many design and implementation details, and also as a function of input signal parameters.

In general terms, the laser should be biased to a level that avoids “clipping” in the output optical signal, or other non-linear response. Clipping occurs when the driver circuitry attempts to drive the laser beyond its operating limits. The most common occurrence of this is when the laser current represented by the DC bias plus the modulated signal goes below the laser threshold current.

However, setting the proper DC bias level is further complicated by the fact that amplitudes of the modulated signal input to the transceiver module can vary over time, such as between or within transmission bursts. For example, the modulated input signal may be a radiofrequency (RF) signal derived from a serial data stream to be transmitted, and may comprise modulated and filtered data bursts containing data at possibly variable symbol rates. Example modulation formats include π/4 DQPSK, QPSK and 16-QAM, using differential or non-differential encoding. An example modulated burst includes a power up, ramp up, preamble, data, forward error correction (FEC), ramp down, guard time and power down in each burst.

The possible use of modulation formats with high peak-to-average ratios (PAR) further complicates the DC bias level control of the laser transmitter. Indeed, the input signal's modulation format may change, depending on data rate, for example, and/or may be unknown to the transceiver module.

Known techniques for laser biasing include constant optical power biasing and envelope-based biasing. With constant optical power biasing, a laser control or driver circuit sets the laser bias to a fixed value for any input RF signal level within the operating range of the transmitter. For input RF signal levels below the operating range, the laser bias is commonly set to a low quiescent level. The circuitry that sets the laser bias commonly utilizes a monitor photodiode packaged together with the laser to determine the bias current required for attaining the desired optical output power.

Another biasing approach responds to the envelope of the modulated input signal rather than to its average amplitude. For example, see U.S. Pat. No. 6,728,277 to Wilson, which is commonly owned with the instant application. In the '277 patent, a laser transmitter uses a dynamic bias signal that is adjusted in response to the detected envelope of the applied RF signal. The '277 patent teaches that dynamic biasing as a function of input signal envelope avoids the clipping problems that might otherwise occur with a fixed biasing, which is another known approach. Envelope biasing also commonly utilizes a monitor photodiode to determine the laser bias required to attain a desired optical output power. “Sagging” is one potentially problematic aspect of envelope based biasing. Sagging arises, for example, when the input signal includes a series of relatively low amplitude symbols. Such a series of low-amplitude symbols will result in a decrease in the laser bias when envelope biasing is utilized. If one or more relatively high amplitude input symbols are next received, the laser bias may be set too low to accommodate these high amplitude symbols and clipping may occur for a period of time until the envelope biasing circuitry increases the laser bias in response to the higher amplitude RF input.

### SUMMARY OF THE INVENTION

The teachings presented herein disclose a method and apparatus for controlling the optical power of a laser in a passive optical network transmitter that outputs a modulated optical signal responsive to a modulated input signal. In one or more embodiments, such a control method comprises detecting the peak amplitude of the modulated input signal, and setting the DC bias level of the laser as a function of the detected peak amplitude.

In at least one such embodiment, the modulated input signal includes modulation bursts, and detecting the peak amplitude of the modulated input signal comprises detecting the peak amplitude for each modulation burst. Correspondingly, setting the DC bias level of the laser as a function of the detected peak amplitude comprises setting the DC bias level of the laser for each modulation burst as a function of the detected peak amplitude of the modulation burst. In this manner, peak detection based biasing control operates on a per modulation burst basis.

Detecting the peak amplitude for each modulation burst may comprise detecting the peak amplitude over all or substantially all of the modulation burst, e.g., over at least preamble and data portions of a given burst but not necessarily over any ramp-up or ramp-down portions. Correspondingly, setting the DC bias level of the laser as a function of the detected peak amplitude comprises dynamically adjusting the DC bias level of the laser as new peak amplitudes are detected over all or substantially all of the modulation burst. In other words, the DC bias level is dynamically adjusted as new peak amplitudes are detected during the course of a given modulation burst. On the other hand, peak detection may be performed over a beginning or preamble portion of each modulation burst. In such embodiments, the DC bias level is dynamically adjusted responsive to peak detection over the preamble, and then maintained over a remaining portion of the modulation burst, e.g., at least over a subsequent data portion of the modulation burst.

Further, in one or more such embodiments, the DC bias level of the laser is set to a desired quiescent level between modulation bursts. Additionally, whether the modulated input signal does or does not include modulation bursts, DC bias level control can be configured to set the DC bias level of the laser as a function of detected peak amplitude during times when the modulated input signal is above a given threshold (e.g., amplitude or power threshold), and to set the DC bias level of the laser to a quiescent bias level during times when the modulated input signal is absent or otherwise below the threshold.

With the above examples in mind, one or more embodiments taught herein provide a laser control circuit for controlling the optical power of a laser in a passive optical network transmitter that outputs a modulated optical signal responsive to a modulated input signal. The laser control circuit comprises a peak hold circuit configured to detect the peak amplitude of the modulated input signal, and a bias control circuit configured to set the DC bias level of the laser as a function of the detected peak amplitude.

In one or more embodiments the laser control circuit performs peak detection and corresponding DC bias level adjustment on a per modulation burst basis. For example, the DC bias level for the laser in each modulation burst is set based on the peak amplitude detected for that burst and peak detection is reset between modulation bursts. Again, peak detection and corresponding adjustment of the DC bias level of the laser may be performed over all or substantially all of each burst, or performed for a beginning portion of each burst, e.g., a preamble portion. In the latter case, the last-adjusted value of the DC bias level as determined from preamble peak detection can be maintained over a remaining portion of the modulation burst, e.g., at least over a subsequent data portion of the modulation burst.

In one or more embodiments, the laser control circuit is included in an Optical Network Unit (ONU) for use in a PON that provides a hybrid coaxial cable-optical fiber network that interfaces cable system subscriber equipment with cable system head-end equipment. In such embodiments, the modulated input signal comprises an electrical signal in the radiofrequency (RF) range.

Non-limiting details for one or more such implementations are set forth in the accompanying drawings and the description below. Other features and advantages will be apparent to those skilled in the art from the description and drawings, and from the claims.

### BRIEF DESCRIPTION OF THE DRAWINGS

FIG. 1 is a block diagram illustrating an implementation of a PON network architecture that includes one or more transceivers configured for peak-based laser biasing as disclosed herein.

FIG. 2 is a block diagram of one embodiment of a laser control circuit configured to detect peak amplitude of an input signal for a laser, and to correspondingly set the DC bias level of the laser as a function of the detected peak amplitude.

FIG. 3 is a flow diagram for one embodiment of processing logic for peak-based laser DC bias level control.

FIG. 4 is a plot of an example modulated input signal waveform in which peak amplitude may be detected for laser DC bias level control.

FIG. 5 is a plot of example DC bias level adjustment responsive to detected peak amplitude.

FIG. 6 is another plot of example DC bias level adjustment responsive to detected peak amplitude.

FIG. 7 is a plot of modulated input signal amplitude and corresponding peak-based DC bias level control for different embodiments of such control.

FIG. 8 is a block diagram of another embodiment of a laser control circuit for peak-based DC bias level control.

FIG. 9 is a schematic diagram of one embodiment of a peak hold circuit.

FIG. 10 is a plot of the output signal versus modulated input signal amplitude, for one embodiment of the peak hold circuit amplifier illustrated in FIG. 9.

FIG. 11 is a logic flow diagram for one embodiment of peak-based laser DC bias level control, which may be implemented by the laser control circuit of FIG. 8, for example.

FIG. 12 is a block diagram of another embodiment of a laser control circuit for peak-based DC bias level control.

FIG. 13 is a logic flow diagram for one embodiment of peak-based laser DC bias level control, which may be implemented by the laser control circuit of FIG. 12, for example.

### DESCRIPTION OF VARIOUS EMBODIMENTS

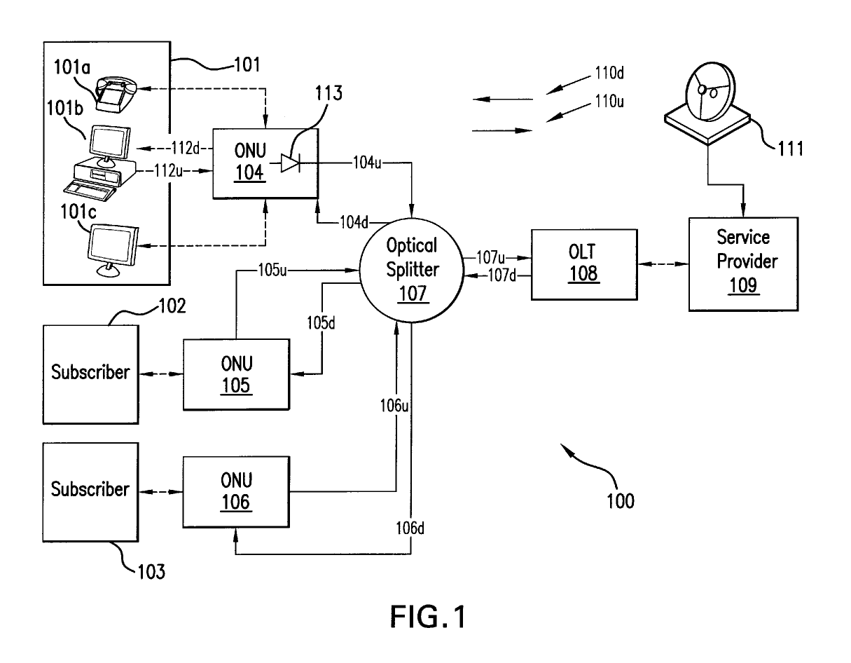

The following is a disclosure of various implementations of controlling the power of a laser used in an optical transmitter configured for use in passive optical networks (“PONs”). By way of non-limiting example, FIG. 1 illustrates an implementation of a network topology associated with a PON 100. The PON 100 comprises, in one or more embodiments, a “DPON” that is configured for operation within a cable system according to the Data Over Cable Service Interface Specification (“DOCSIS”).

With reference to the illustration, data transmission in the direction of arrow 110d will be referred to as “downstream” and data transmission in the direction of arrow 110u will be referred to as “upstream.” Solid lines represent data exchange via an optical link (e.g., one or more fiber optic cables or fibers) and dotted lines represent data exchange via a non-optical link (e.g., one or more copper or other electrically conductive cables). Data transmission via optical links can be bidirectional, even over single fibers. Accordingly, in some implementations, subscribers (e.g., 101-103) receive and transmit data over a single fiber optic cable.

Service provider 109 provides one or more data services to a group of subscribers (e.g., 101-103). In some cases, the data services include, for example, television, telephone (e.g., Voice over IP or “VolP”) and internet connectivity. In some implementations, television services are interactive to accommodate features such as “on-demand” viewing of content. The service provider 109 may generate some or all of the content that the subscribers receive, or it may receive some or all of the content from third parties via a data link. For example, the service provider 109 can be coupled to the PSTN for telephone service, e.g., via E1 or T1 connection(s). The service provider 109 can receive certain television content via head end 111, which also includes a CMTS for internet/data connectivity. Television content can include additional data that is generated or provided by the service provider 109, e.g., data regarding programming schedules.

The service provider 109, as part of providing data services to a group of subscribers, can be adapted to receive data from those subscribers. For television services, the service provider 109 receives data from subscribers indicative of, e.g., purchases and/or selection of “on-demand” type material or changes to subscription parameters (e.g., adding or deleting certain services). For telephone and internet services, the service provider 109 receives data originating from subscribers, thereby enabling bi-directional communication.

The service provider 109 is adapted to provide the data services content (e.g., bi-directional telephone, television and internet content) via a non-optical link to an optical line termination unit (“OLT”) 108. The link between OLT 108 and service provider 109 can include one or more copper or other electrically conductive cables. The OLT 108 is adapted to receive data from the service provider 109 in one format (e.g., electrical) and convert the data to an optical format. The OLT 108 is further adapted to receive data from subscribers (e.g., 101-103) in an optical format and convert it to another format (e.g., electrical) for transmission to the service provider 109. In this implementation, the OLT 108 may be analogized to an electro-optical transceiver that: (1) receives upstream data in an optical format from subscribers (e.g., 107u); (2) transmits downstream data in an optical format to subscribers (e.g., 107d); (3) transmits the upstream data in electrical format to the service provider 109; and, (4) receives the downstream data from the service provider in an electrical format.

To transmit the various data from the service provider 109 (e.g., telephone, television and internet) on as few optical fibers as possible, the OLT 108 performs multiplexing. In some implementations, the OLT 108 generates two or more optical signals representative of the data from the service provider 109. Each signal has a different wavelength (e.g., 1490 nm for continuous downstream data and 1550 nm for continuous downstream video) and is transmitted along a single fiber. This technique is sometimes referred to as “wavelength division multiplexing.”

Also, as certain data from the service provider 109 may be destined for only a particular subscriber (e.g., downstream voice data for a particular subscriber's telephone call, the downstream data for a particular subscriber's internet connection or the particular “on demand” video content requested by a particular subscriber), some implementations of the OLT 108 employ time division multiplexing (“TDM”). TDM allows the service provider 109 to target content delivery to a particular subscriber (e.g., to one or all of 101-103).

The OLT 108 is coupled to an optical splitter 107 via an optical link. The link can include a single optical fiber through which the OLT 108 transmits and receives optical signals (e.g., 107d and 107u, respectively). The optical splitter 107 splits the incoming optical signal (107d) from the OLT 108 into multiple, substantially identical copies of the original incoming optical signal (e.g., 104d, 105d, 106d). Depending on the implementation, each optical splitter 107 splits the incoming optical signal into sixteen or more (e.g., 32 or 64) substantially identical copies. In an implementation that splits the incoming optical signal into sixteen substantially identical copies, there are a maximum of sixteen subscribers. Generally speaking, the number of subscribers associated with a given optical splitter is equal to or less than the number of substantially identical copies of the incoming optical signal.

In a PON implementation, the splitting is done in a passive manner (i.e., no active electronics are associated with the optical splitter 107). Each of the signals from the optical splitter 107 (e.g., 104d, 105d, 106d) is sent to a subscriber (e.g., 101-103, respectively) via an optical link. Also, the optical splitter 107 receives data from subscribers via optical links. The optical splitter 107 combines (e.g., multiplexes) the optical signals (104u, 105u, 106u) from the multiple optical links into a single upstream optical signal (107u) that is transmitted to the OLT 108.

In some implementations, each subscriber is equipped with an ONU that employs time division multiple access (TDMA). This allows the service provider 109, with appropriate de-multiplexing, to identify the subscriber from whom each packet of data originated. Further, in some implementations, upstream and downstream data between a subscriber (e.g., one of 101-103) and the optical splitter 107 is transmitted bi-directionally over a single fiber optic cable.

The optical splitter 107 typically is disposed in a location remote from the service provider. For example, in a PON implemented for subscribers in a residential area, a given neighborhood will have an associated optical splitter 107 that is coupled, via the OLT 108, to the service provider 109. In a given PON, there can be many optical splitters 107, each coupled to an OLT 108 via an optical link. Multiple optical splitters 107 can be coupled to a single OLT 108. Some implementations employ more than one OLT and/or service provider.

The optical splitter 107 provides the substantially identical downstream signals (104d, 105d, 106d) to optical network units (104, 105, 106, respectively) associated with subscribers (101,102,103, respectively). In some implementations, each respective PON module is disposed in the vicinity of the subscriber's location. For example, an ONU may be disposed outside a subscriber's home (e.g., near other utility connections). In the context of the network architecture, each ONU operates in a substantially identical fashion. Accordingly, only the functionality of ONU 104 will be discussed in detail.

ONU 104 receives the downstream signal 104d and demultiplexes the signal into its constituent optical signals. These constituent optical signals are converted to corresponding electrical signals (according to a protocol) and transmitted via electrical links to the appropriate hardware. In some implementations, electrical signals are generated that correspond to telephone (VolP), data/internet and television service. For example, electrical signals corresponding to telephone service are coupled to traditional telephone wiring at the subscriber's location, which ultimately connects with the subscriber's phone 101a. Television signals (e.g., for a cable-compatible television 101c) are converted to appropriate RF signals and transmitted on coaxial cable installed at a subscriber's location. Data/internet services (e.g., for a personal computer (PC) 101b and associated cable modem) also may be provided via coaxial cable. Downstream data signal 112d comprises data transmitted to PC 101b. Upstream data signal 112u comprises an RF signal transmitted by PC 101b.

As telephone, internet/data and television services all can be bidirectional, the ONU receives electrical signals that correspond to data originating from the subscriber location (e.g., upstream data signal 112u). This upstream data is converted to an optical signal 104u by the laser 113 (which can be part of the transceiver module within the ONU 104) and transmitted to the optical splitter 107. The optical splitter 107 combines optical signal 104u with the optical signals from other ONUs (e.g., 105u and 106u) for transmission to the OLT 108 (as signal 107u).

Thus, as was previously noted, it will be understood that PON 100 is a DPON in one or more embodiments. In DPON embodiments, the PON 100 interfaces a number of cable modems or other subscriber equipment to cable head end equipment, e.g., a CMTS. In such implementations, downstream electrical signals are transmitted from the CMTS and targeted to one or more subscribers. The OLT 108 converts these downstream signals into optical signals for transmission over the PON 100 to the subscriber(s). Correspondingly, ONUs at the subscriber locations convert the downstream optical signals back into electrical signals for coupling into subscriber equipment. In complementary fashion, the ONU at a given subscriber location converts upstream electrical signals into optical signals for transmission over the PON 100, The OLT 108 converts these upstream optical signals back into electrical signals for coupling into the CMTS.

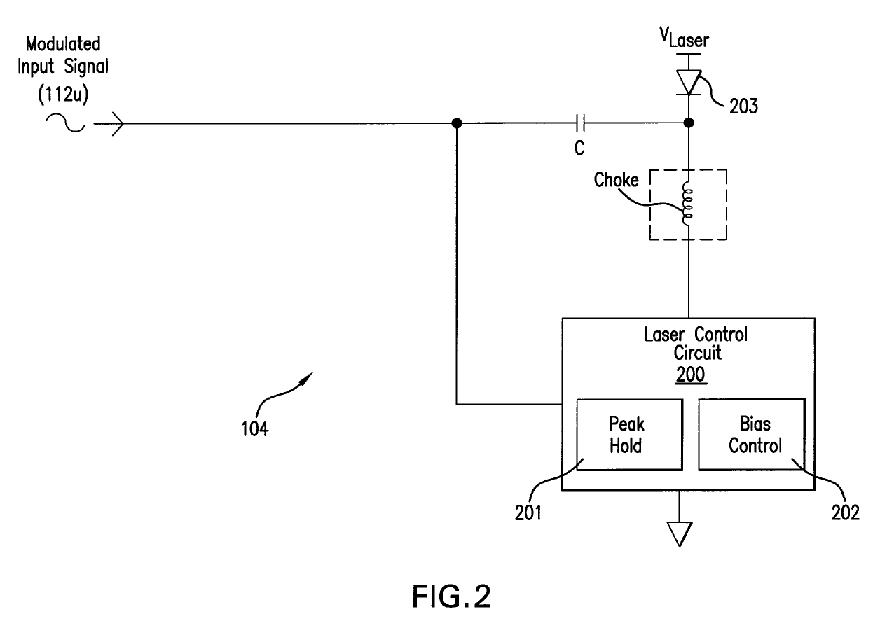

An aspect of such operation that is of interest herein relates to transceiver module laser power control, e.g., controlling the optical output power of the optical transmission laser within the ONU 104. As such, FIG. 2 illustrates a laser control circuit 200 for controlling the power of the laser 203 by setting the DC bias level of the laser 203. Here, the laser 203 is used in the illustrated PON to convert a modulated input signal, e.g., an RF input signal originating at a subscriber location, into a corresponding optical signal for transmission in the passive optical network. The laser control circuit 200 is implemented, for example, in each one or more of the ONUs illustrated in FIG. 1.

The illustrated embodiment of the laser control circuit 200 comprises a peak hold circuit 201 configured to detect the peak amplitude of the modulated input signal (e.g., RF signal 112u), and a bias control circuit 202 configured to set the DC bias level of the laser 203 as a function of the detected peak amplitude. The laser 203 provides an output optical signal responsive to the input signal, where in the illustrated configuration, the input signal couples into the cathode side of the laser (diode) 203 through a capacitor C. The anode side of the laser 203 is coupled to a supply voltage V_{LASER}.

Those skilled in the art will appreciate that the optical output power of the laser 203, which may be implemented as a semiconductor laser diode, is a non-linear function of the laser diode's drive current. That drive current includes two components: the modulated input signal, e.g., the RF input signal originating from a cable subscriber's equipment, and the DC bias current provided by voltage-mode or current-mode DC bias level control of the laser 203. The DC bias level may be understood as establishing the laser diode's operating point. This operating point resides within the drive current range where the laser diode 203 is in lasing mode operation. Generally, the operating point should be set so that the drive current of the laser 203 during modulation by the modulated input signal remains above its threshold current for lasing mode operation and below any excess drive current levels.

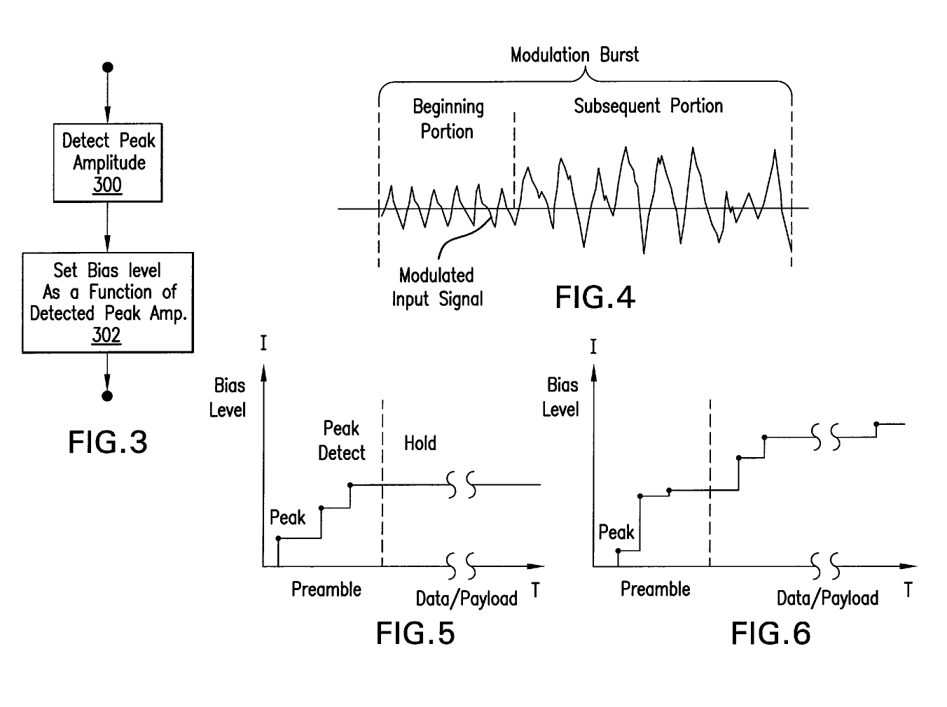

FIG. 3 is a flow diagram illustrating a method of controlling the optical power of a laser by setting the DC bias level of that laser. The method may be implemented via one or more embodiments of the laser control circuit 200. In operation, the laser control circuit 200 detects the peak amplitude of the modulated input signal (Block 300). The particular implementation of peak detection may be adapted to the known or expected nature of the modulated input signal. For example, peak detection may be performed only when the modulated input signal is present or otherwise above a defined amplitude or power threshold. Additionally, or alternatively, peak detection may be performed on per-burst basis, at least in embodiments where the laser control circuit 200 is intended to receive a modulated input signal having modulation bursts. It should be broadly understood that the laser control circuit 200 can be operative to perform peak detection on continuous and discontinuous signals (burst-mode or otherwise).

Also, for any given portion of the modulated input signal, there may be many “local” peaks, some higher than others. Thus, detecting “the” peak amplitude of the modulated input signal should be understood as detecting the peak amplitude, which may be done on a magnitude basis, occurring in that portion of the signal over which peak detection is performed. More particularly, detecting the peak amplitude should be understood as a dynamic process. For example, the laser control circuit 200 makes corresponding adjustments in the DC bias level of the laser 203 as new peak amplitudes are detected over time for the modulated input signal.

Peak amplitude may be detected using positive-going peak detection circuitry, negative-going detection circuitry, or some combination of the two, or based on absolute value (magnitude) detection. It also should be understood that peak amplitude detection in the context of this disclosure should be understood in a real-world, practical sense. That is, in detecting the peak amplitude of the modulated input signal, the involved peak detection circuitry may include voltage offsets or other error sources, such that the “detected peak amplitude” of the modulated input signal is the peak amplitude as detected within the precision of the involved circuitry.

In any case, the illustrated processing of FIG. 3 continues with the laser control circuit 200 setting the DC bias level of the laser 203 as a function of the detected peak amplitude (Block 302). In at least one embodiment, the laser control circuit 200 is configured to set the DC bias level of the laser 203 additionally as a function of a known clipping point for the laser. For example, the laser control circuit 200 may include a memory device that stores clipping point information for the laser 203, which may be related to the value of V_{LASER}. Equivalently, the clipping point may be indicated by a voltage or current divider circuit, a voltage reference circuit, or by a programmed value (resistor, capacitor, etc.).

Regardless of such details, one or more embodiments of the laser control circuit 200 effectively “map” the detected peak amplitude into a corresponding DC bias level for the laser 203. For example, the laser control circuit 200 may include analog circuitry that controls the DC bias level of the laser proportional to the detected peak amplitude. In one embodiment, the detected peak amplitude is represented as a voltage on a capacitor or other charge storage element, and that voltage is used to control the magnitude of a bias current through the laser. Broadly, the laser control circuit 200 is configured in one or more embodiments to generate a peak detection signal proportional to peak amplitude of the RF signal. In at least one such embodiment, the bias control circuit 202 is configured to set the DC bias level of the laser 203 by setting or otherwise controlling a DC bias current or voltage for setting the DC bias level of the laser 203 as a function of the detection signal. For example, the bias control circuit 202 is configured to set the DC bias level of the laser 203 by setting or otherwise controlling a bias current or voltage of the laser 203 proportional to the detected peak amplitude, e.g., in proportion to the detected peak signal of the modulated RF signal.

In terms of bias control implementation, in at least one embodiment, the laser control circuit 200 is configured to set the DC bias level of the laser 203 by dynamically adjusting the DC bias level of the laser 203 over the beginning portion of the RF signal responsive to performing peak detection over that beginning portion, and to maintain that adjusted DC bias level for a subsequent portion of the RF signal. For example, referring now to FIG. 4, one sees an illustration of an RF signal as might be input to the laser control circuit 200 and laser 203 as the modulated input signal. The illustrated signal is not to scale, nor is the amplitude modulation present in the signal necessarily meant to suggest a particular modulation format. Rather, the illustration shows that a given modulated input signal may have a beginning portion, including a preamble portion, and a subsequent or remaining portion, such as a data or payload portion. (Note that such beginning and remaining portions also may include ramp-up, ramp-down, FEC, and other elements.)

Further, FIG. 4 illustrates that the modulation characteristics and/or the signal amplitudes may be significantly different for the beginning and subsequent portions of the modulated input signal. In at least one embodiment, the laser control circuit 200 is configured to receive a modulated input signal having modulation bursts, where each burst has a preamble portion and a subsequent data or payload portion. Binary Phase Shift Keying (BPSK) or other lower-order modulation formats may be used for the preamble portion, while QPSK, 8PSK, 16QAM or other higher-order modulation formats may be used for the data or payload portion.

In one embodiment for operation with burst-mode input signals, the laser control circuit 200 is configured to dynamically detect the peak amplitude for at least the beginning portion of each burst, and to set the DC bias level of the laser 203 for each burst as a function of the peak amplitude detected for the burst. The laser control circuit 200 in at least one such embodiment is configured to reset peak detection for each burst, such as by resetting the peak hold circuit 201 between each burst. Further, in at least one such embodiment, the laser control circuit 200 is configured to set the DC bias level to a desired quiescent level between bursts of the modulated input signal.

In any case, FIG. 5 illustrates an example of DC bias level adjustment for an embodiment of the laser control circuit 200 that dynamically adjusts the DC bias level of the laser responsive to peak detection over the preamble, but holds that adjusted level over the subsequent data portion. (The last adjusted value of DC bias level as determined from peak detection for the preamble is held over the data portion.) The illustration plots bias current through the laser responsive to detected peak amplitude, but the same operations can be applied to embodiments that adjust laser bias voltage. Note, too, that the illustrated operation can be obtained by suspending further peak detection after the preamble portion of the signal, or by configuring bias control not to respond to peaks detected after the preamble portion.

In another embodiment, the laser control circuit 200 is configured to perform peak detection for the duration of a given modulation burst in the modulated input signal, and to dynamically adjust the DC bias level over the duration of the modulation burst responsive to peak detection. FIG. 6 provides an example illustration of such operation, wherein DC bias level adjustment is dynamic over the duration of each modulation burst. As such, the DC bias level changes after the preamble ends, as subsequently higher peak amplitudes are detected in the data/payload portion of the signal.

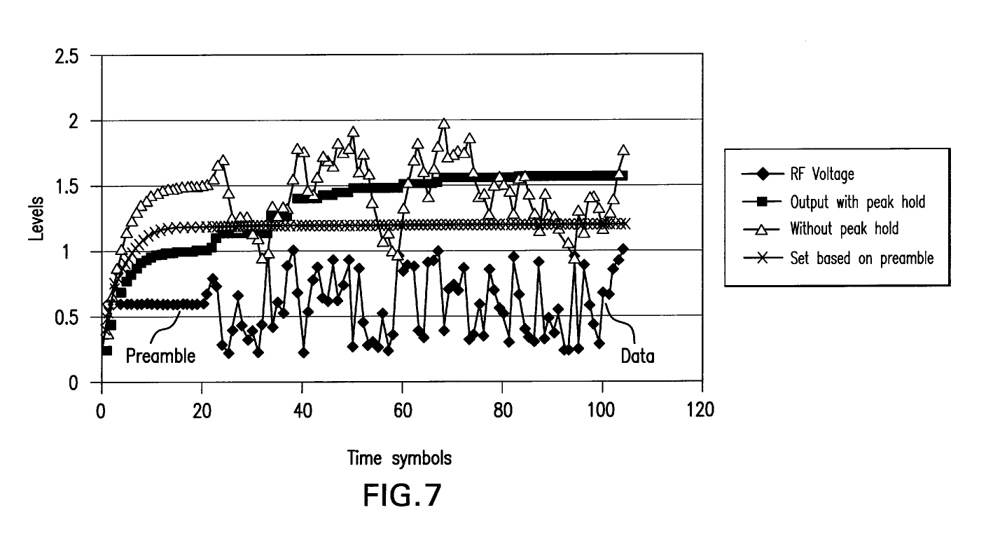

FIG. 7 provides a more detailed example, comparing preamble-based peak hold versus peak hold over the preamble and data portions of the modulated input signal. More particularly, FIG. 7 plots the modulated input signal level over a number of symbol periods for that signal, and additionally plots resultant DC bias levels for the laser 203 assuming that DC bias level adjustments are made responsive only to peak amplitude as detected for the preamble portion of the modulated input signal. FIG. 7 further plots resultant DC bias levels for the laser 203 assuming that DC bias level adjustments are made responsive to peak amplitude as detected preamble and data portions of the modulated input signal.

The particular relationship between detected peak amplitude and corresponding DC bias level for the laser 203 can be a proportional relationship. Indeed, it was noted earlier that the laser control circuit 200 in one or more embodiments is configured to set the DC bias level proportional to the detected peak amplitude. In at least one such embodiment, the bias control circuit 202 is configured to set the bias current or voltage of the laser 203 proportional to the detected peak amplitude according to a defined proportionality relating peak amplitude to desired DC bias level. For example, one or more proportionalities may be defined through analog gain settings, or by other circuitry. In any case, in one embodiment, the laser control circuit 200 is configured to perform peak detection over a preamble portion of the RF signal and to set the DC bias level based on the detected peak amplitude of the preamble portion. Here, the defined proportionality can account for a known or expected relationship between peak amplitude of the preamble portion and peak amplitude of a subsequent data portion of the RF signal. The laser control circuit 200 may, for example, be configured to add an offset to a DC bias level determined for the detected peak amplitude of the preamble, to account for a known or expected increase in maximum signal amplitude in the following data portion.

With these various embodiments in mind, it will be understood by those skilled in the art that the laser control circuit 200 in one or more embodiments is configured to map a detection signal value representing the peak amplitude detected by the peak hold circuit 201 to a bias signal value for setting the DC bias level of the laser 203, according to a predefined mapping function. Where the RF signal is a modulated signal, the laser control circuit 200 may be configured to map a detection signal value based at least in part on one or more known or expected modulation parameters of the modulated signal.

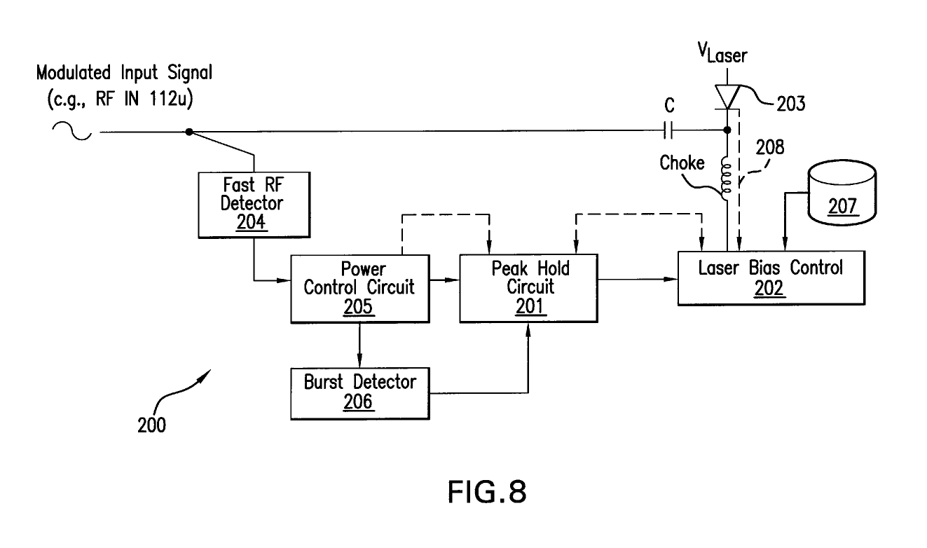

FIG. 8 illustrates an embodiment of the laser control circuit 200 in more detail. As an example, the illustrated laser control circuit 200 may be disposed inside of an ONU, e.g., ONU 104. In that context, the laser control circuit 200 receives a modulated input signal, e.g., an RF signal generated at the subscriber location (112u of FIG. 1). An RF detector 204 detects the presence of signal 112u, and passes the signal to the power control circuit 205. In at least one embodiment, the power control circuit 205, which may be an analog circuit, includes one or more amplifier circuits and one or more voltage references. For example, it may provide one or more amplified versions of the RF signal, each such signal possibly having a different gain. Amplified versions of the RF signal may facilitate peak detection by the peak hold circuit 201, and/or may facilitate burst detection by the burst detection circuit 206. Thus, the burst detection circuit 206 and the peak hold circuit 201 may operate responsive to amplified signals from the power control circuit 205. Of course, either or both of those circuits may interface directly to the modulated input signal.

Regardless, the burst detection circuit 206 provides an output signal indicating whether a burst is detected or not. More broadly, in at least one embodiment, the laser control circuit 200 includes a signal presence detection circuit that is configured to detect a presence of the RF signal, e.g., the burst detection circuit 206. The laser control circuit 200 thus can be configured to reset or otherwise enable the peak hold circuit 201 responsive to the presence detection circuit detecting the presence of the RF signal at an input to the laser control circuit 200. In such embodiments, the laser control circuit 200 also may be configured to set the DC bias level of the laser 203 to a desired quiescent value if the presence detection circuit indicates that the RF signal is not present at the input of the laser control circuit 200.

With particular reference to the burst detection circuit 206, in operation it determines the presence of a modulation burst in signal 112u. (Note that signal 112u may not be present or may otherwise have a very low amplitude or power between modulation bursts. Thus, modulation bursts can be detected by detecting whether the amplitude (or power) of the signal 112u is at or above a defined threshold.) If an RF burst is detected, the burst detector generates a signal that activates the peak hold circuit 201 for the duration of the burst, or for a portion of the burst, according to the desired configuration of the laser control circuit 200.

Correspondingly, the peak hold circuit 201 captures the maximum value of the amplitude signal generated by the power control circuit 205. The peak hold circuit 201 can be configured to update or otherwise reset, e.g., (1) after a predetermined time period and/or (2) upon detection of a subsequent burst. Because the amplitude of signal 112u may vary within a single burst, at least for some modulation schemes, at least some embodiments of the laser control circuit 200 are configured such that the peak hold circuit 201 updates the detected peak value during a burst. That is, the detected peak amplitude changes dynamically, as new peak amplitudes are detected for the modulation burst.

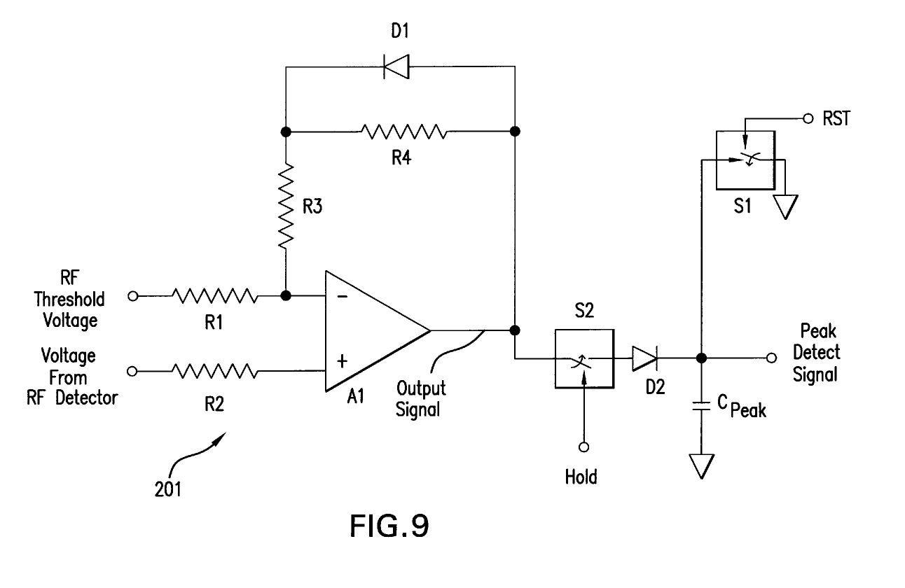

As a non-limiting example, FIG. 9 illustrates an embodiment of the peak hold circuit 201, as implemented in one or more embodiments of the laser control circuit 200. The illustrated circuit includes resistors R1, R2, R3, and R4, an operational amplifier A1, diodes D1 and D2, switch S1 and optionally switch S2, an a capacitor C_{PEAK}.

In more detail, the amplifier A1 includes an input/feedback network that includes resistors R1, R2, R3, and R4, and diode D1. The amplifier A1 takes as its input signals a threshold voltage for peak detection—which may be provided by the power control circuit 205—and the modulated input signal (112u), or another signal derived from the modulated input signal. For example, the burst detection circuit 206 or the power control circuit 205 may provide an amplified version of the modulated input signal to the peak hold circuit 201, which may be more advantageous for threshold detection and/or peak detection. In any case, the output from amplifier A1 is a function of the input voltages and the amplifier circuit gain.

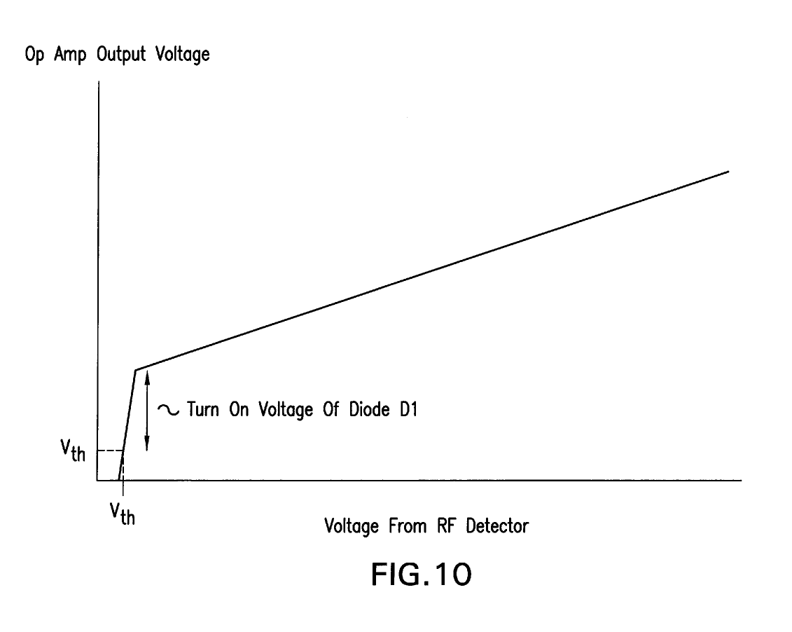

With the illustrated configuration, and particularly with use of the diode D1 in the feedback path of the amplifier Al, the low voltage peak detection gain is given by (R4+R3+R1)/R1. For higher voltages, the peak detection gain is given by (R3+R1)/R1. A plot of the resultant output signal voltage from the amplifier Al for given low/high gains appears in FIG. 10. It should be noted that the output optical power of the laser 203 (laser power) versus RF input voltage/current has similar shape. Namely, the laser power is zero or very low up to some threshold for the modulated input signal, and then abruptly jumps to a minimum “on state” power. From there, the laser power increases linearly, with a lower slope.

Turning back to circuit details, one sees that if the optional switch S2 is closed the output signal from the amplifier A1 feeds through the diode D2 into the capacitor C_{PEAK}. Assuming low leakage for the capacitor C_{PEAK} and high circuit impedance, one sees that the capacitor C_{PEAK} charges to the highest voltage fed through the diode D2, and thus provides a peak detect signal for the modulated input signal. The peak detect signal couples to a high-impedance input in the bias control circuit 202, for example. In any case, one sees that peak detection can be disabled by opening the switch S2. The laser control circuit 200 can be configured to generate a “hold” signal for such purposes, and this function can be used to stop peak detection at certain times, such as after the preamble portion of the modulated input signal.

One also sees that the capacitor C_{PEAK} can be discharged through the switch S2, which may be operated via a “reset” signal. Thus, the laser control circuit 200 can be configured to reset the peak hold circuit 201 as needed, such as by resetting it for peak detection in each of a series of modulation bursts.

In that regard, if the peak hold circuit 201, as it is configured in one or more embodiments, does not receive a signal from the burst detection circuit 206 that indicates the presence of a modulation burst, it instructs or otherwise signals the bias control circuit 202 to set the laser bias to zero or some other desired quiescent level. For example, it may assert or de-assert a signal to indicate that condition. Alternatively, the bias control circuit 202 may interpret a zero or near zero value for the detected peak amplitude as an indicator that quiescent biasing should be used.

If a modulation burst is detected by the burst detection circuit 206, the peak hold circuit 201 transmits a peak detection signal to the bias control circuit 202 that is representative of the peak amplitude as currently detected for the modulation burst in signal 112u. The detected peak amplitude is used to calculate the appropriate bias for the laser 203. Such DC bias level adjustment generally is dynamic, changing as new peak amplitudes are detected. The laser bias control 205 accesses memory 207 that has stored therein the clipping point for the associated laser 203. In some implementations, the memory is disposed within the laser bias control 205 or is otherwise associated with the laser control circuit 200. In some implementations, the laser 203 generates a signal 208, received by the bias control circuit 202 that identifies the clipping point. For example, the signal may be an analog (level) signal, and the processing control circuits in the bias control circuit 202 may be analog. In some implementations, signal 208 is a value stored in memory 207 and provided to the bias control circuit 202. In such embodiments, the laser bias control circuit 202 may include digital processing elements or, again, it may include analog processing elements. Regardless, the laser's DC bias level is set such that the peak amplitude of the modulation burst combined with the DC bias level will approach but not go beyond the clipping point of the laser.

As a non-limiting voltage mode example, it may be assumed that the laser 203 has a clipping point of 10 volts. Assuming the peak hold circuit 201 has determined that a given modulation burst in the modulated input signal has a peak amplitude of 6 volts, the bias control circuit 202 will set the laser DC bias to about 4 volts. Of course, that DC bias level may change depending on the signal voltage references in use, e.g., such as whether signals are referenced to a zero voltage signal ground, or to some midpoint between zero volts and the laser's maximum operating voltage. Similar examples apply for current-mode biasing, even for voltage-mode peak detection. That is, the bias control circuit 202 may be configured to map detected peak voltages into corresponding DC bias current values for the laser 203. Using the earlier example of a detected peak amplitude of 6 volts, the bias control circuit 202 may set the laser's DC bias current to 8 mA, for example. Of course, the actual bias current will depend on the type of laser, the type of PON involved, etc.

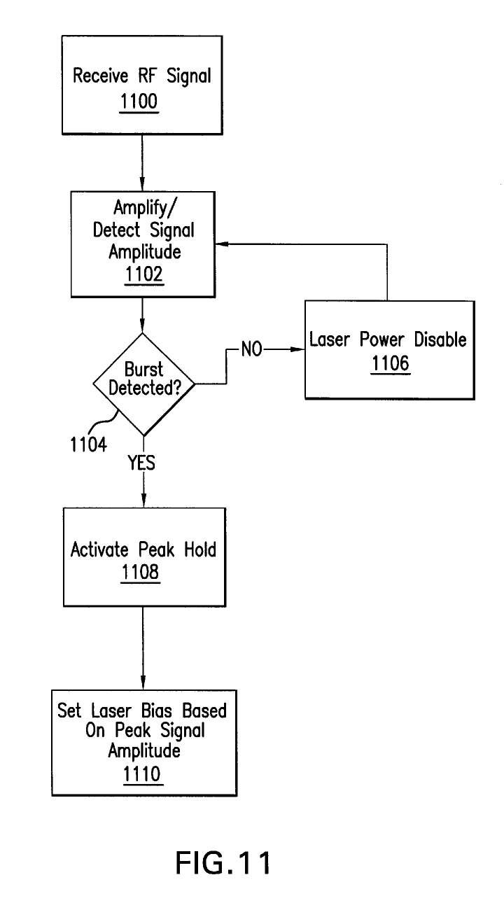

With the above examples in mind, FIG. 11 illustrates one embodiment of a method of DC bias level control that can be implemented by the laser control circuit 200, e.g., by the circuit configuration shown in FIG. 8.

First, a modulated input signal is received at the input to the laser 203 and the laser control circuit 200 (Block 1100). The amplitude of the modulated input signal is determined or otherwise evaluated (Block 1102) as a basis for determining whether the signal includes a modulation burst or is otherwise above a defined amplitude or power threshold (Block 1104).

If no burst is detected or if the modulated input signal is otherwise deemed not present because its amplitude and/or power are below a detection threshold, the laser bias is set to zero or some other quiescent level (Block 1106). The process then returns to Block 1102, where signal amplitude detection continues. If a burst is detected, peak hold is activated (Block 1108) which dynamically determines the peak signal amplitude. The DC bias level of the laser 203 is set based on the detected peak signal amplitude (Block 1110). Although the algorithm for setting the laser's DC bias may vary based on the implementation, one suitable algorithm is VLaser Bias≦(VClip−VPeak), where VLaser Bias is the DC bias voltage, VClip is the input voltage at which the laser clips and VPeak is the (detected) peak signal amplitude. Of course, as noted, other embodiments of the laser control circuit 200 implement current-mode control, and may thus control a DC bias current level based on detected peak amplitude. One such control sets DC bias current through the laser 203 in proportion to the detected peak amplitude.

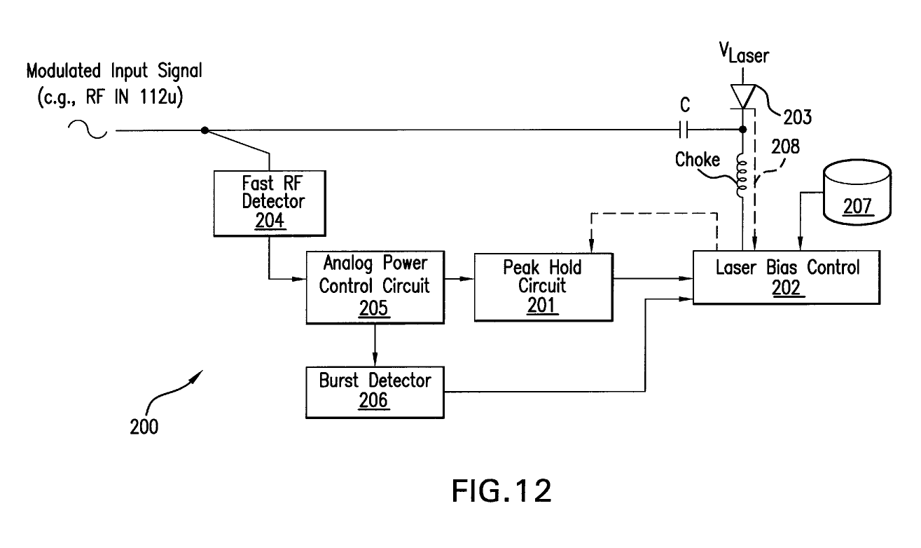

FIG. 12 illustrates another embodiment of the laser control circuit 200. The circuit receives a modulated input signal, e.g., an RF signal generated at a subscriber location such as the signal 112u of FIG. 1. The RF detector 204 here is configured to detect the presence of signal 112u, and pass that signal along to the power control circuit 205. In turn, the power control circuit 205 generates an amplitude signal representative of the amplitude of signal 112u. For example, it may apply pre-amplification, or at least provide voltage/current buffering for the modulated input signal. Such buffering allows detection of the modulated input signal and corresponding operation of the power control circuit 200, without undesirably “loading” the modulated input signal. In any case, the amplitude signal derived from the modulated input signal is coupled to the burst detection circuit 206 and to the peak hold circuit 201.

The burst detection circuit 206 determines the presence of a modulation burst in signal 112u, based on the amplified signal from the power control circuit 205. If the burst detection circuit 206 does not detect the presence of such a burst, it indicates that condition to the bias control circuit 202, which thus sets the laser bias to zero or some other desired quiescent level. If a burst is detected, the burst detection circuit 206 indicates this condition, e.g., it asserts a signal, and the laser bias control circuit 202 correspondingly sets the DC bias level of the laser 203 responsive to the output from the peak hold circuit 201, i.e., as a function of the detected peak amplitude of the modulated input signal.

In this implementation, the peak hold circuit 201 may always be enabled, or at least may not operate responsive to the burst detection circuit 206. Regardless, the peak hold circuit 201 detects the peak amplitude of the signal 112u signal by capturing the maximum (or minimum) value of the amplitude signal generated by the power control circuit 205. The peak hold circuit 201 can be configured to update or otherwise reset, e.g., (1) after a predetermined time period and/or (2) upon detection of a subsequent burst. Because, in some modulation schemes, the amplitude of signal 112u may vary within a single burst, it may be desirable for the peak hold circuit 201 to dynamically update the peak value during a burst, i.e., to continue detecting new peak amplitudes throughout a modulation burst, or at least throughout one or more portions of a modulation burst.

As before, the peak hold circuit 201 provides a peak detection signal to the bias control circuit 202 that is representative of the peak amplitude detected for a given modulation burst in signal 112u. Also, as before, the bias control circuit 202 sets the DC bias level of the laser 203 as a function of the detected peak amplitude. As part of such adjustment, the bias control circuit 202 may access a memory 207 that has stored therein the clipping point for the laser 203. In some implementations, the memory 207 is disposed within the bias control circuit 202 or is otherwise associated with laser control circuit 200. In some implementations, the laser 203 (or circuitry associated therewith) generates a signal 208, which is representative of the clipping point, and which provides a clipping point value to the bias control circuit 202. Further, in some implementations, a clipping point value is stored in memory 207, for use by the bias control circuit 202 in setting the DC bias level of the laser 203, such that the detected peak amplitude plus the DC bias level just approaches the clipping point of the laser.

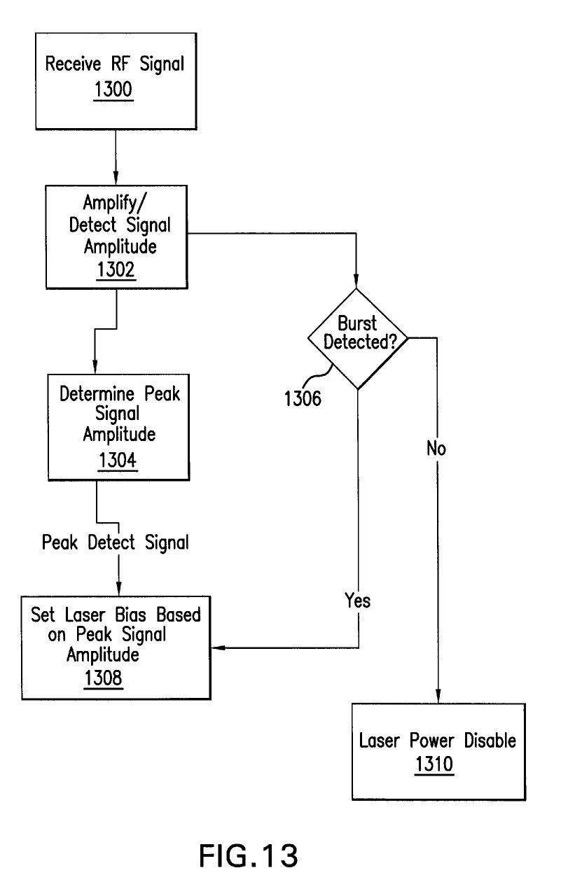

FIG. 13 illustrates a method of laser level bias control that is implemented using the embodiment of the laser control circuit 200 shown in FIG. 12. First, an RF signal is received at the input to the laser control circuit 200 and the laser 203, e.g., RF signal 112u (Block 1300). The power control circuit 205, for example, buffers/amplifies the signal to provide an amplitude signal for burst detection, peak detection, etc. (Block 1302).

The peak signal amplitude is determined (Block 1304) and it is determined whether the signal includes an RF burst (Block 1306). That is, peak detection and burst detection may be done in parallel, and may be ongoing processes. As such, the peak hold circuit 201 may provide an “active” peak detection signal to the bias control circuit 202, even when there is no detected burst in the modulated input signal. However, in this configuration, the bias control circuit 202 may be configured to use a zero or other default quiescent bias setting unless the burst detection circuit 206 indicates the presence of a burst in the signal 112u, in which case it sets the DC bias level as a function of the detected peak amplitude (Block 1308).

Also, note that if no burst is detected, the laser control circuit 200 may disable laser power, e.g., it may provide a control signal to disable V_{LASER} or other supply voltage/current into the laser 203 (Block 1310). While not explicitly diagrammed as such in FIG. 13, it will be understood that the bias control of Block 1308 can be configured to work in complement with any laser power control in Block 1310. That is, where the laser control circuit 200 shuts off laser power if no burst is detected by the burst detection circuit 206, the bias control circuit 202 may be configured to use a zero bias during such times.

Regardless of such details, it will be understood by those skilled in the art that the foregoing implementations provide various advantages. For example, DPONs can convert input modulation signals with different modulation formats into correspondingly modulated optical output signals, with DC level biasing of the laser advantageously adapted dynamically for differing signal modulations as a function of detected peak amplitudes. This dynamic adaptation provides operating advantages, particularly in view of the potentially significant differences in modulation characteristics exhibited by different modulation schemes. For example, different modulation formats generally have different ratios between peak RF signal amplitude and average RF signal amplitude, referred to as PAR, or peak-to-average ratio. Further, some formats, such as QPSK, have no variation in RF signal amplitude, while other formats, such as 64QAM, have relatively large variations in RF signal amplitude and, therefore, a large ratio between the peak and average RF signal amplitude.

Broadly, the advantageous peak-based DC biasing level control taught herein provides for a more optimal setting of a laser's DC bias level, where the optimal setting varies with the modulation format, as compared to systems that rely on constant optical power-based biasing, envelope-based biasing, fixed biasing, etc. Further, those skilled in the art will appreciate that the present invention is not limited by the foregoing discussion or the accompanying drawings. Indeed, the present invention is limited only by the following claims and their legal equivalents.

What is claimed is:

1. A method of controlling the optical power of a laser in a passive optical network transmitter that outputs a modulated optical signal responsive to a modulated input signal, the method comprising:
detecting the peak amplitude of the modulated input signal; and
setting the DC bias level of the laser as a function of the detected peak amplitude.

2. The method of claim 1, wherein the modulated input signal includes modulation bursts, and wherein detecting the peak amplitude of the modulated input signal comprises detecting the peak amplitude for each modulation burst, and setting the DC bias level of the laser for each modulation burst as a function of the detected peak amplitude of the modulation burst.

3. The method of claim 2, further comprising resetting a peak detection circuit used to detect the peak amplitude of the modulated input signal for each modulation burst.

4. The method of claim 2, wherein detecting the peak amplitude for each modulation burst comprises detecting the peak amplitude over all or substantially all of the modulation burst, and wherein setting the DC bias level of the laser as a function of the detected peak amplitude comprises dynamically adjusting the DC bias level of the laser as new peak amplitudes are detected over all or substantially all of the modulation burst.

5. The method of claim 2, wherein detecting the peak amplitude for each modulation burst comprises detecting the peak amplitude over a preamble portion of the modulation burst, and wherein setting the DC bias level of the laser as a function of the detected peak amplitude comprises dynamically adjusting the DC bias level of the laser as new peak amplitudes are detected over the preamble portion of the modulation burst and maintaining the adjusted DC bias level over a remaining portion of the modulation burst.

6. The method of claim 5, wherein dynamically adjusting the DC bias level of the laser as new peak amplitudes are detected over the preamble portion of the modulation burst and maintaining the adjusted DC bias level over a remaining portion of the modulation burst comprises dynamically adjusting the DC bias level over the preamble portion of the modulation burst according to a defined proportionality that accounts for a known or expected relationship between peak amplitude of the preamble portion and peak amplitude of the remaining portion of the modulation burst.

7. The method of claim 2, further comprising setting the DC bias level of the laser to a desired quiescent level for times between modulation bursts of the modulation input signal.

8. The method of claim 1, wherein setting the DC bias level of the laser as a function of the detected peak amplitude comprises setting a DC bias voltage or current for the laser according to a defined proportionality relating peak amplitude to a desired DC bias level.

9. The method of claim 1, further comprising setting the DC bias level of the laser additionally as a function of a known clipping point for the laser.

10. The method of claim 1, wherein setting the DC bias level of the laser as a function of the detected peak amplitude comprises mapping a detection signal value representing the detected peak amplitude to a bias level control value for controlling the DC bias level of the laser, based at least in part on one or more known or expected modulation parameters of the modulated input signal.

11. A laser control circuit for controlling the optical power of a laser in a passive optical network transmitter that outputs a modulated optical signal responsive to a modulated input signal, the laser control circuit comprising:
a peak hold circuit configured to detect the peak amplitude of the modulated input signal; and
a bias control circuit configured to set the DC bias level of the laser as a function of the detected peak amplitude.

12. The laser control circuit of claim 11, wherein the modulated input signal includes modulation bursts, and wherein the laser control circuit is configured to detect the peak amplitude of the modulated input signal by detecting the peak amplitude for each modulation burst, and setting the DC bias level of the laser for each modulation burst as a function of the detected peak amplitude of the modulation burst.

13. The laser control circuit of claim 12, wherein the laser control circuit is configured to reset the peak detection circuit for each modulation burst, such that peak amplitude is detected a new for each modulation burst of the modulated input signal.

14. The laser control circuit of claim 12, wherein the laser control circuit is configured to detect the peak amplitude over all or substantially all of each modulation burst, and wherein the bias control circuit is configured to set the DC bias level of the laser for each modulation burst by dynamically adjusting the DC bias level of the laser as new peak amplitudes are detected by the peak detection circuit over all or substantially all of the modulation burst.

15. The laser control circuit of claim 12, wherein the laser control circuit is configured to detect the peak amplitude for each modulation burst over a preamble portion of the modulation burst, and wherein the bias control circuit is configured to set the DC bias level of the laser for each modulation burst by dynamically adjusting the DC bias level of the laser as new peak amplitudes are detected over the preamble portion of the modulation burst and maintaining the adjusted DC bias level over a remaining portion of the modulation burst.

16. The laser control circuit of claim 15, wherein the laser control circuit is configured to dynamically adjust the DC bias level of the laser as new peak amplitudes are detected over the preamble portion of the modulation burst according to a defined proportionality that accounts for a known or expected relationship between peak amplitude of the preamble portion and peak amplitude of the remaining portion of the modulation burst.

17. The laser control circuit of claim 12, wherein the laser control circuit is configured to set the DC bias level of the laser to a desired quiescent level for times between modulation bursts of the modulation input signal.

18. The laser control circuit of claim 11, wherein the laser control circuit is configured to set the DC bias level of the laser as a function of the detected peak amplitude by setting a DC bias voltage or current for the laser according to a defined proportionality relating peak amplitude to a desired DC bias level.

19. The laser control circuit of claim 11, wherein the laser control circuit is configured to set the DC bias level of the laser additionally as a function of a known clipping point for the laser.

20. The laser control circuit of claim 11, wherein the laser control circuit is configured to set the DC bias level of the laser as a function of the detected peak amplitude based on mapping a detection signal value, as provided by the peak detection circuit and representing the detected peak amplitude, to a bias level control value for controlling the DC bias level of the laser, based at least in part on one or more known or expected modulation parameters of the modulated input signal.

21. The laser control circuit of claim 11, wherein the laser control circuit is configured to set the DC bias level of the laser to a desired quiescent value if a presence detection circuit included within the laser control circuit indicates that the modulated input signal is not present at an input of the laser control circuit.

22. The laser control circuit of claim 11, wherein the laser control circuit further comprises a power control circuit that includes or is associated with the bias control circuit, and wherein the power control circuit provides one or more amplified signals corresponding to the modulated input signal, and wherein the presence detection circuit and the peak hold circuit operate responsive to one of the one or more amplified signals.
